(19) United States
(12) Patent Application Publication
(10) Pub. No.: US 2010/0088751 A1
(43) Pub. Date: Apr. 8, 2010

(54) COMMUNICATION SYSTEM, TERMINAL CONTROL UNIT AND COMMUNICATION METHOD

(75) Inventors: Tatsuhiro ANDO, Kawasaki (JP); Takaaki Kidachi, Kawasaki (JP); Tatsuhiro Furuya, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/561,679

(22) Filed: Sep. 17, 2009

(30) Foreign Application Priority Data
Oct. 2, 2008 (JP) 2008-257750

(51) Int. Cl. H04L 9/32; H04B 7/14; H04L 12/26

(52) U.S. Cl. 726/5; 370/315; 370/252

(57) ABSTRACT

A terminal control unit and method are provided. The terminal control unit which manages information about a mobile unit which transmits data to a relay unit of transferring data to another relay unit depending on source IP address, includes a terminal communication information storing unit which stores a destination IP address and a terminal identifier for identifying the mobile unit for every relay unit; and a terminal identifier transmitting unit which transmits a combination of the destination IP address and the terminal identifier stored in the terminal communication information storing unit to the mobile unit, upon receipt of a terminal identifier assignment request from the mobile unit, requesting assignment of the terminal identifier to the mobile unit.

### CROSS-REFERENCE TO RELATED APPLICATION

This application is related to and claims priority to Japanese Patent Application No. 2008-257750, filed on Oct. 2, 2008, and incorporated by reference herein.

### BACKGROUND

1. Field

The embodiments discussed herein are directed to a communication system, a mobile unit, a terminal control unit, and a communication method.

2. Description of the Related Art

Studies of technology concerning a network system using Mobile IP (hereinafter referred to as a mobile IP network) such as WiMAX (Worldwide Interoperability for Microwave Access) are being conducted.

When MVNO (Mobile Virtual Network Operator) and ISP (Internet Service Provider) provide services in the mobile IP network, there are two possible places to set HA (Home Agent). FIGS. 1 and 2 illustrate a conventional mobile IP network. In FIGS. 1 and 2, WiMAX is taken as an example. The mobile IP network illustrated in each of FIGS. 1 and 2 has a WiMAX core network (CSN: Connectivity Services Network), a WiMAX access network, an MVNO network of the A company, and an MVNO network of the B company. In FIGS. 1 and 2, an intra-server 908 is an intranet server for providing A's own MVNO service, and an intra-server 909 is an intranet server for providing B's own MVNO service.

As one possible place to set HA by the MVNO and the ISP (hereinafter, simply referred to as MVNO), HA (HA 906 in the example of FIG. 1) can be set in the WiMAX core network (CSN), as illustrated in FIG. 1. When the HA is set in the WiMAX core network, the MVNO can provide MS (Mobile Station: mobile unit) 901 with a service for directly connecting to the Internet not through the MVNO network.

As the other possible place, the HAs (HA 910 and HA 911 in the example of FIG. 2) can be set in the MVNO networks, as illustrated in FIG. 2. When the HAs are set in the MVNO networks, the MVNO and the like can provide the MS 901 with the MVNO own services such as content delivery.

The MVNO and the like will determine the place to set HA, according to the operation policy of the WiMAX business operator or the operation policy and service format of the MVNO.

Conventionally, a technique provides an MVNO system with a database of clients and venders to provide various services in reply to the clients' demands.

The above-mentioned prior technique, however, cannot switch the HA to which the MS gains access, according to a service the MS makes use of, and therefore, the MVNO cannot perform a flexible operation.

In the conventional mobile IP network, MS cannot gain access to any other HA than a single HA. When the HA 906 is set in the WiMAX core network, as illustrated in FIG. 1, the MS 901 can gain access to the Internet but cannot communicate with a device within the MVNO network (the intra-server 908 and the like as illustrated in FIG. 1). Accordingly the MVNO cannot provide the MS with the MVNO's own services.

As illustrated in FIG. 1, the MS 901 seems to be able to make communication with a device within the MVNO network by passing through the HA 906, the Internet network, and FW (Fire Wall) 907 within the MVNO network. In this case, however, since a path of traffic cannot be specified, QoS (Quality of Service) cannot be guaranteed. Further, the FW 907 needs some scheme for passing a service.

As illustrated in FIG. 2, when the HA 910 and the HA 911 are set in the MVNO networks, the MS 901 cannot receive any service provided by the MVNO other than the contracted MVNO. For example, it is assumed that a user of the MS 901 has a contract with the A company of MVNO in the example illustrated in FIG. 2. In this case, the MS 901 can receive the A's own providing service but cannot receive the B's own providing service.

Further, when the HA is set in the MVNO network, the MS has to pass through the HA in the MVNO network also in order to receive the Internet connection service. In the example illustrated in FIG. 2, the MS 901 establishes a connection always through the HA 910. Namely, even when the MS 901 uses the Internet connection service, it has to pass through the HA 910. This increases loads on the HA 910 disadvantageously.

As mentioned above, wherever the HA is arranged, either in the WiMAX core network or the MVNO network, there are various problems respectively. The MVNO cannot switch the HA to which the MS gains access, according to a service which the MS tries to use and cannot perform a flexible operation.

### SUMMARY

It is an aspect of the embodiments discussed herein to provide a communication system having a mobile unit, a terminal control unit for managing information about the mobile unit, and a relay unit for transferring data transmitted from the mobile unit to another relay unit depending on source IP address, wherein the mobile unit relay unit includes a communication information storing unit which stores a terminal identifier for identifying the mobile unit for every relay unit, which is notified from the terminal control unit to the mobile unit depending on a request from the mobile unit and a mobile IP address assigned to the mobile unit for every terminal identifier; and an IP address transmitting unit which transmits the mobile IP address stored in the communication information storing unit correspondingly to the terminal identifier, to the mobile unit, upon receipt of an IP address assignment request and the terminal identifier of the mobile unit from the mobile unit, and the mobile unit includes a communication unit which establishes communication with a predetermined terminal, with the mobile IP address received from the IP address transmitting unit as the source IP address.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF DRAWINGS

FIG. 1 illustrates a conventional mobile IP network;

FIG. 2 illustrates a conventional mobile IP network;

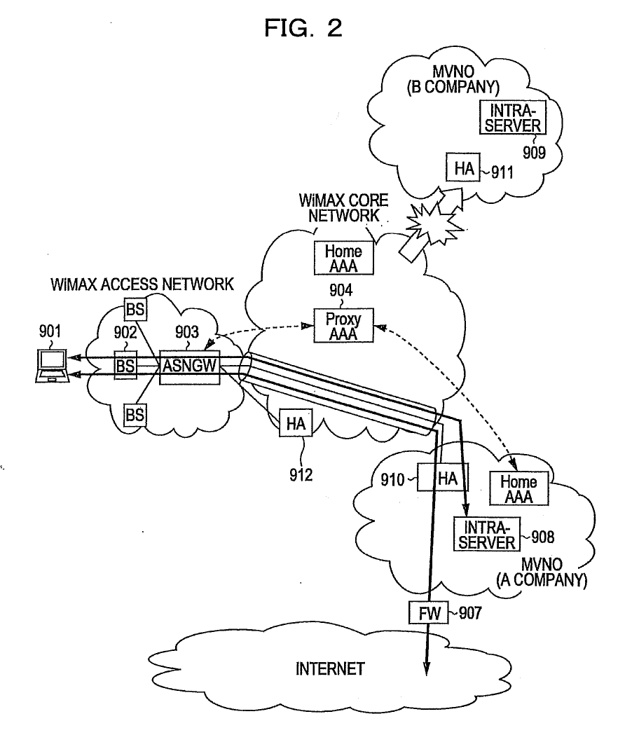

FIG. 3 illustrates a mobile IP network according to a first embodiment;

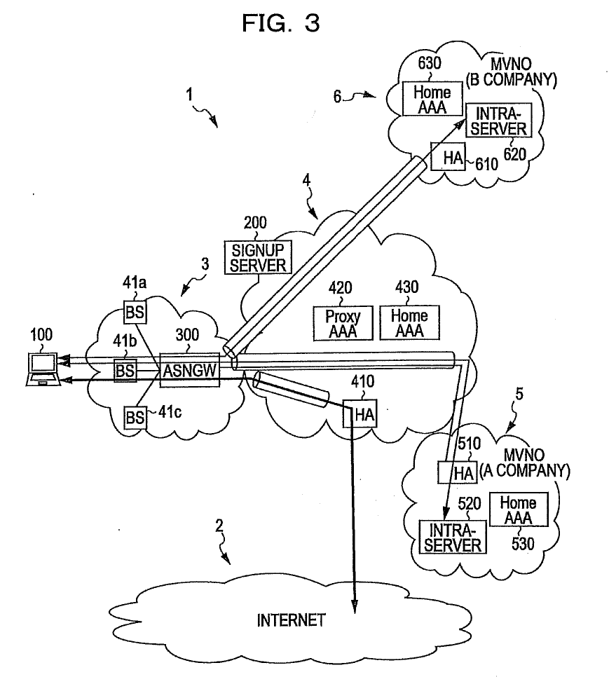

FIG. 4 illustrates a MS illustrated in FIG. 3;

FIG. 5 illustrates a terminal information table;

FIG. 6 illustrates a WiMAX frame created by the MS;

FIG. 7 illustrates a format of GMH;

FIG. 8 illustrates an IP packet created by the intra-server and a WiMAX frame created by BS;

FIG. 9 illustrates a signup server illustrated in FIG. 3;

FIG. 10 illustrates an example of a user account table;

FIG. 11 illustrates an example of a terminal communication information table;

FIG. 12 illustrates a ASN-GW;

FIG. 13 is a view illustrating an example of a communication information table;

FIG. 14 is a sequence view illustrating the flow of the processing of the respective units included in the mobile IP network according to a first embodiment, after startup of the MS;

FIG. 15 is a sequence view illustrating the flow of the processing of the respective units included in the mobile IP network according to the first embodiment, when the MS works as a virtual MS;

FIG. 16 illustrates a Home AAA;

FIG. 17 illustrates exemplary processing of the respective units included in the mobile IP network according to a second embodiment, when the MS works as a virtual MS;

FIG. 18 illustrates exemplary processing of the respective units included in the mobile IP network when a virtual MAC address assigned to the MS is released;

FIG. 19 illustrates exemplary processing of the respective units included in the mobile IP network when the Home AAA measures the elapsed time; and

FIG. 20 illustrates an exemplary the terminal communication information table.

### DESCRIPTION OF EMBODIMENTS

An exemplary embodiment is disclosed for a case where the communication system, mobile unit, terminal control unit, and communication method disclosed in this specification are applied to the WiMAX. However, the communication system, mobile unit, terminal control unit, and communication method disclosed herein may also be applied to a network using a mobile IP other than the WiMAX.

A mobile IP network 1 according to an exemplary first embodiment includes a mobile IP network 1 that has HAs in both the WiMAX core network and the MVNO network. In other words, the MVNO arranges the HA in either the WiMAX core network or the MVNO network in the conventional mobile IP network; however, the HAs are arranged in both the WiMAX core network and the MVNO network in the mobile IP network 1 of the first embodiment.

After the MS gains access to the mobile IP network 1, it is registered as a mobile IP client by a predetermined HA. The MS establishes communication through the HA having it registered as the mobile IP client. Under this state, however, the MS already has to establish communication through the HA to which the MS gains a first access. As disclosed above, there is a problem that the MS cannot use any service supplied through an HA other than the HA to which the MS gains a fist access. Further, it causes an increase in loads on the HA. The HA to which the MS gains a first access is previously determined by a system.

When the MS in the mobile IP network 1 according to the first embodiment uses a service provided through any other HA than the accessed HA, it gets access to a predetermined terminal control unit (a signup server 200 described later) at first. More The MS transmits a virtual MAC address assignment request for assigning a virtual MAC address to the signup server 200. Upon receipt of the virtual MAC address assignment request, the signup server 200 assigns a virtual MAC address to the MS. The signup server 200 transmits, to the MS, the virtual MAC addresses for the number of HAs allowed to connect to the MS, of all the HAs arranged in the mobile IP network 1. The signup server 200 also transmits the information other than the virtual MAC addresses to the MS. The information other than the virtual MAC addresses will be described later.

For example, it is assumed that there are two services provided over the mobile IP network 1. The two services are defined as service 102 and service 103. A predetermined MS 100 has to pass through an HA 510 in order to use the service 102 and pass through an HA 610 in order to use the service 103. The MS 100 is allowed to use the services 102 and 103.

Under such a condition, the signup server 200 transmits virtual MAC addresses “Y.Y.Y.Y” and “Z.Z.Z.Z” for use in getting access to the HAs 510 and 610, to the MS 100, upon receipt of the virtual MAC address assignment request from the MS 100. Here, it is assumed that the signup server 200 holds the virtual MAC addresses “Y.Y.Y.Y” and “Z.Z.Z.Z”, as the respective virtual MAC addresses to be assigned to the MS 100 and the connected IP addresses correspondingly to the respective HAs 510 and 610.

The MS 100 establishes communication while selecting one of the virtual MAC addresses depending on the service the MS wants to use. When the MS 100 uses a predetermined service, it transmits an HoA obtaining request including the virtual MAC address corresponding to the service to an ASN-GW (Access Service Network Gateway) 300 and the HA, to obtain an HoA. The MS 100 makes use of the service through access to the server using the obtained HoA. In the following description, the MS which establishes communication using a virtual MAC address will be referred to as “virtual MS”.

For example, when the MS 100 uses the service 102 in the above example, it transmits the HoA obtaining request including the virtual MAC address “Y.Y.Y.Y” to the ASN-GW 300. The MS 100 obtains the HoA corresponding to the virtual MAC address “Y.Y.Y.Y” from the ASN-GW 300. The MS 100 communicates with the server which provides the service 102, through the HA 510, using the obtained HoA. Thus, the MS 100 can make use of the service 102.

Meanwhile, when the MS 100 uses the service 103 in the above example, it transmits the HoA obtaining request including the virtual MAC address “Z.Z.Z.Z” to the ASN-GW 300. The MS 100 obtains the HoA corresponding to the virtual MAC address “Z.Z.Z.Z” from the ASN-GW 300. The MS 100 communicates with the server which provides the service 103, through the HA 610, using the obtained HoA. Thus, the MS 100 can make use of the service 103.

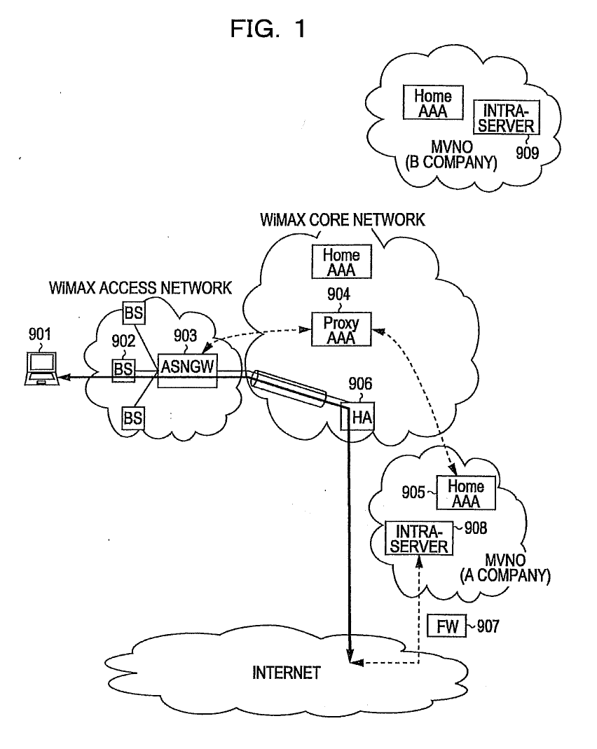

FIG. 1 illustrates a mobile IP network 1. As illustrated in FIG. 1, the mobile IP network 1 includes the Internet network 2, a WiMAX access network 3, a WiMAX core network 4, an MVNO network 5, and an MVNO network 6. The MS 100 conducts wireless communication through the WiMAX access network 3. In FIG. 1, it is assumed that the MVNO network 5 is built by the A company of MVNQ and that the MVNO network 6 is built by the B company of MVNO.

The Internet network 2 is a network formed of various ISPs, where various services such as content delivery are provided. In this specification, it is assumed that the Internet network is not a network where a specified MVNO or ISP provides its own service. Namely, the MS 100 can make use of the services provided over the Internet network without permission through authentication. A service provided over the Internet network may be referred to as “Internet connection service”.

The WiMAX access network 3 is a network for realizing wireless communication with the MS 100, including BSs (Base Station) 41a to 41c and an ASN-GW (Access Service Network Gateway) 300.

Each of the BSs 41a to 41c forms a cell that is a wireless communication area having a predetermined space, to establish wireless communication with the MS positioned in its own cell. In the example illustrated in FIG. 1, since the BS 41b has the MS 100 within its own cell, it carries out wireless communication with the MS 100.

The ASN-GW 300 is a gateway in the WiMAX access network, which terminates a wireless related function, including a mobile IP client function, a Radius client function, and an FA (Foreign Agent) function in the mobile IP. The ASN-GW 300 in the first embodiment manages a plurality of virtual MSs for every MS and manages the mobile IP clients for every virtual MS. Namely, the ASN-GW 300 controls access to the HA in every virtual MS.

The WiMAX core network 4 has a function of IP core network in the WiMAX, and includes an HA 410, a Proxy AAA (Authentication Authorization Accounting) 420, a Home AAA 430, and a signup server 200.

The HA 410 manages the positional information of the MS 100 and when the MS 100 moves from a home network, the HA 410 intercepts the transfer of the packets to the MS 100 and transfers the packets to the MS 100 at the transfer destination through an IP tunnel.

The Proxy AAA 420 transfers the data (packets and frames) transmitted from the ASN-GW 300 to the Home AAA 430 and one of the Home AAA 530 and 630 described later. The Proxy AAA 420 transfers the data received from the Home AAA 430, 530 or 630 to the ASN-GW 300.

When the Home AAA 430 receives a network access authentication request from the MS 100 after startup of the MS 100, it performs the network access authentication processing. The Home AAA 430 obtains a communication record of the MS 100 for the purpose of accounting.

The signup server 200 controls the MS 100's access to the MVNO network 5 or 6, assigning a virtual MAC address to the MS 100 or stopping the assignment of the virtual MAC address to the MS 100. When receiving the virtual MAC address assignment request from the MS 100, the signup server 200 transmits the virtual MAC addresses for the number of HAs which the MS 100 is allowed to connect to, of the HAs arranged within the mobile IP network 1, to the MS 100. The signup server 200 transmits, to the MS, the service ID for identifying a service provided through the HA and the IP address of the server (hereinafter, referred to as “connected IP address”) that is a connection destination when the MS 100 makes use of the service.

The MVNO network 5 is a network formed by the MVNO, and includes the HA 510, an intra-server 520, and a Home AAA 530. The HA 510 manages the positional information of the MS within the MVNO network 5 and when the MS moves from a home network, the HA 510 intercepts the transfer of the packets to the MS and transfers the packets to the MS at the transfer destination through the IP tunnel.

The intra-server 520 is a server for providing the original service of the A company forming the MVNO network 5, such as a chat server and a content delivery server. It is assumed that the intra-server 520 in the first embodiment is to provide a chat service.

The Home AAA 530 performs the network access authentication processing upon receipt of the network access authentication request from the MS 100, similarly to the Home AAA 430.

The MVNO network 6 is a network built by the MVNO, including the HA 610, an intra-server 620, and a Home AAA 630. The HA 610, the intra-server 620, and the Home AAA 630 respectively perform similar processing as the above-mentioned HA 510, intra-server 520, and Home AAA 530. In this specification, it is assumed that the intra-server 620 is to provide a content delivery service.

When the MS 100 gains access to the mobile IP network 1, it is registered as the mobile IP client by a predetermined HA. Here, it is assumed that the HA 410 registers the MS 100 as the mobile IP client by the HA 410. The MS 100 obtains the HoA issued from the HA 410. Thus, the MS 100 is allowed to make use of the Internet connection service lithe HA 410.

When the MS 100 accepts a user's operation of using the original service provided by the MVNO, it transmits a virtual MAC address assignment request to the signup server 200. Upon receipt of the virtual MAC address assignment request, the signup server 200 transmits the virtual MAC address, the service ID, and the connected IP address to the MS 100 after the authentication processing.

For example, in the case illustrated in FIG. 1, the MS 100 is allowed to have access to the HA 510 and the HA 610. In other words, the MS 100 is allowed to use a chat service provided by the intra-server 520 through the HA 510 and a content delivery service provided by the intra-server 620 through the HA 610.

In this case, the signup server 200 transmits the virtual MAC address for getting access to the HA 510 and the virtual MAC address for getting access to the HA 610, to the MS 100. The signup server 200 also transmits the service IDs of the chat service and the content delivery service and the IP addresses (the connected IP addresses) of the intra-servers 520 and 620 to the MS 100.

The signup server 200 transmits the virtual MAC address assigned to the MS 100, the connected IP address, the HoA (Home Address) used for the MS 100 to establish communication, and the IP address of the HA, to the ASN-GW 300. The ASN-GW 300 stores the virtual MAC address, the connected IP address, the HoA, and the IP address of the HA received from the signup server 200 into a predetermined storing unit. As a result, the ASN-GW 300 is enabled to issue the HoA to the MS 100 and control the data transfer to the MS 100.

The MS 100 shows the title of a service indicated by the service ID received from the signup server 200 on a predetermined display unit, to prompt a user to select which service he or she wants to use. The MS 100 transmits the DHCP Discover to the ASN-GW 300, using the virtual MAC address corresponding to the service selected by the user. Upon receipt of the DHCP Discover, the ASN-GW 300 transmits a registration request to the HA corresponding to the virtual MAC address received from the MS 100. The ASN-GW 300 obtains the HoA from the HA and transmits the obtained HoA to the MS 100. The MS 100 conducts communication by using the HoA received from the ASN-GW 300.

For example, when the MS 100 makes use of the chat service provided by the intra-server 520, it transmits the DHCP Discover including the virtual MAC address corresponding to the HA 510 to the ASN-GW 300. The ASN-GW 300 transmits the registration request of the MS 100 working as the virtual MS to the HA 510. The ASN-GW 300 obtains the HoA and transmits the obtained HoA to the MS 100. The MS 100 establishes communication by using the received HoA. Namely, the MS 100 is enabled to communicate with the intra-server 520 through the BS 41b, the ASN-GW 300, and the HA 510. Thus, the MS 100 can make use of the chat service provided by the intra-server 520.

On the other hand, for example, when the MS 100 makes use of the content delivery service provided by the intra-server 620, it transmits the DHCP Discover including the virtual MAC address corresponding to the HA 610, to the ASN-GW 300. The ASN-GW 300 obtains the HoA by transmitting the registration request of the MS 100 working as the virtual MS to the HA 610 and transmits the obtained HoA to the MS 100. Thus, the MS 100 is enabled to communicate with the intra-server 620 by using the received HoA through the HA 610 and make use of the content delivery service provided by the intra-server 620.

As mentioned above, the MS 100 according to the first embodiment can establish communication by changing the HoA depending on the service it wants to use and thus can switch the connecting HAs depending on the service to be used. Therefore, the MS 100 can make use of the original service provided by the MVNO with which the MS 100 is not under contract, in addition to the original service of the contracted MVNO.

Since the MS 100 switches the connecting HA for every service according to the mobile IP network 1 in the first embodiment, it is possible to offload the traffic other than the original service provided by the MVNO to the HA in the WiMAX core network. Therefore, it is possible to restrain the traffic on the MVNO network.

As mentioned above, according to the mobile IP network 1 in the first embodiment, the MVNO can provide its own original service without increasing loads on the respective units arranged within the MVNO network. Therefore, the MVNO can perform a flexible operation by using the mobile IP network 1 in the first embodiment.

The structure of the MS 100, the signup server 200, and the ASN-GW 300 illustrated in FIG. 1 will be described. In the following description, it is assumed that the MS 100 is registered at first by the HA 410 as the mobile IP client after the startup of the MS 100. Further, it is assumed that the MS 100 is allowed to use the chat service provided by the intra-server 520 and the content delivery service provided by the intra-server 620.

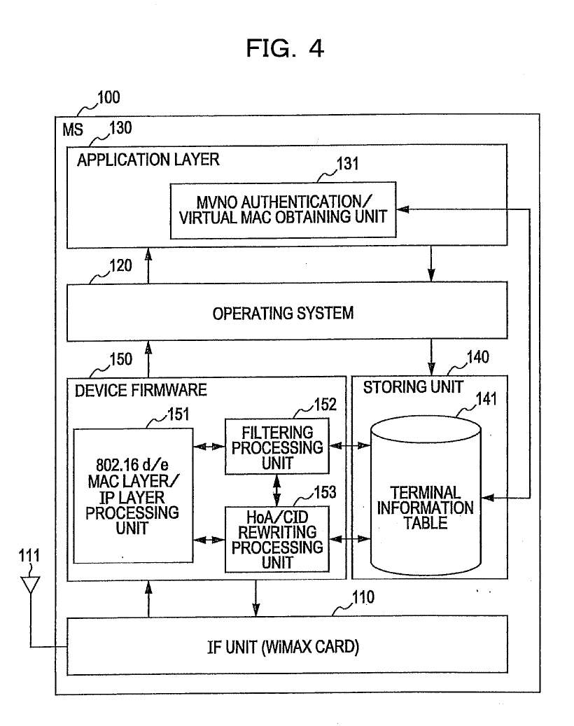

At The structure of the MS 100 illustrated in FIG. 1 will be described. FIG. 4 illustrates the MS 100 illustrated in FIG. 1. As illustrated in FIG. 4, the MS 100 includes an interface (hereinafter, referred to as “IF”) 110, an antenna 111, an operating system 120, an application layer 130, a storing unit 140, and a device firmware 150.

The IF unit 110 is a WiMAX network card for performing wireless processing in a physical layer. The antenna 111 is an antenna conforming to the 802.16d/e standard. The MS 100 transmits data (frames, etc.) externally through the IF unit 110 and the antenna 111. The MS 100 receives data from the outside through the antenna 111 and the IF unit 110.

The operating system 120 is the basic software for performing the management operation of the hardware within the MS 100, for example, Windows (registered trademark). The operating system 120 attaches an IP header to the datagram received from the application layer 130. The operating system 120 sets the IP address of a server (intra-server 520) providing a service in DA (Destination Address: destination IP address) of the IP header. The operating system 120 sets the HoA issued by the HA 410 at the startup of the MS 100 in SA (Source Address: source IP address) of the IP header.

The application layer 130 controls a predetermined display unit to show a screen for accepting a user's operation to use the MVNO's own service. The application layer 130 receives a user's input of user ID and password on the screen. The user ID may be defined as, for example, NAI (Network Access Identifier). The application layer 130 includes a MVNO authentication/virtual MAC obtaining unit 131.

The MVNO authentication/virtual MAC obtaining unit 131 transmits the virtual MAC address assignment request to the signup server 200 and obtains the virtual MAC address from the signup server 200.

When the MVNO authentication/virtual MAC obtaining unit 131 receives the user's operation to use the MVNO's own service, it transmits the virtual MAC address assignment request including the user ID and the password to the signup server 200. The MVNO authentication/virtual MAC obtaining unit 131 receives the virtual MAC address, the service ID of the service the MS 100 can use, and the IP address of the server that becomes a connection destination when using the service, from the signup server 200. The MVNO authentication/virtual MAC obtaining unit 131 stores the received various information in the storing unit 140.

The MS 100 is allowed to use the chat service provided by the intra-server 520 and the content delivery service provided by the intra-server 620. Therefore, the MVNO authentication/virtual MAC obtaining unit 131 receive the virtual MAC address used for getting access to the HA 510 and the virtual MAC address used for getting access to the HA 610, from the signup server 200. The MVNO authentication/virtual MAC obtaining unit 131 receives the service ID of the chat service and the service ID of the content delivery service. The MVNO authentication/virtual MAC obtaining unit 131 receives the IP address of the intra-server 520 and the IP address of the intra-server 620.

The storing unit 140 is a storing device for storing various information, and includes a terminal information table 141. The terminal information table 141 stores various information which the MVNO authentication/virtual MAC obtaining unit 131 and the device firmware 150 have received from the signup server 200.

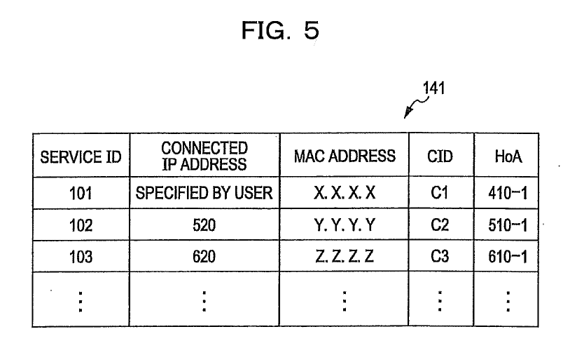

One example of the terminal information table 141 is illustrated in FIG. 5. As illustrated in FIG. 5, the terminal information table 141 includes the items of service ID, connected IP address, MAC address, CID (Connection Identifier), and HoA.

The “service ID” indicates the identification information for identifying a service provided on the mobile IP network 1, as mentioned above. In the example illustrated in FIG. 5, the service ID “101” indicates the Internet connection service. The service ID “102” indicates the chat service provided by the intra-server 520. The service ID “103” indicates the content delivery service provided by the intra-server 620.

The “connected IP address” indicates the IP address of a server which provides the service indicated by the corresponding service ID. In the example illustrated in FIG. 5, the reference numerals “520” and “620” attached to the intra-servers 520 and 620 illustrated in FIG. 1 are the IP addresses of the intra-servers 520 and 620. Further, in the example illustrated in FIG. 5, the “specified by user” in the connected IP address indicates an arbitrary IP address. This is for avoiding the MS 100 from always gaining access to the same IP address when it uses the Internet connection service.

The “MAC address” indicates the MAC address for use in the communication by the MS 100, or the virtual MAC address. The MS 100 is registered by the HA 410 as the mobile IP client at its startup. The registration processing is performed by using the actual MAC address assigned to the MS 100. Namely, the MAC address “X.X.X.X” corresponding to the service ID “101” is the actual MAC address assigned to the MS 100. Meanwhile, the MAC address “Y.Y.Y.Y” corresponding to the service ID “102” and the MAC address “Z.Z.Z.Z” corresponding to the service ID “103” are the virtual MAC addresses.

The “CID” is an identifier for identifying the connection and the direction (upstream and downstream direction between MS-BS) between the MS 100 and the respective BS 41a to 41c. As illustrated in FIG. 5, the MS 100 stores the different “CIDs” (only in the upstream direction) for every MAC address, in the terminal information table 141. The “CID” is stored by the device firmware 150 described later.

The “HoA” indicates the HoA assigned to the MS 100 by the HA 410. In the example illustrated in FIG. 5, the information with “N” (N is numeric value) attached after the reference numbers of the HA 410, 510, and 620 illustrated in FIG. 1 is defined as HoA.

The device firmware 150 includes an 802.16d/eMAC layer/IP layer processing unit 151, a filtering processing unit 152, and a HoA/CID rewiring processing unit 153. The 802.16d/eMAC layer/IP layer processing unit 151 performs the MAC layer and IP layer processing on the data transmitted and received by the MS 100. The 802.16d/eMAC layer/IP layer processing unit 151 rewrites the SA of the IP packet received from the operating system 120 and attaches the GMH (Generic MAC Header), which is the MAC header, to the IP packet. The 802.16d/eMAC layer/IP layer processing unit 151 performs the SA rewriting processing and the GMH attaching processing in the filtering processing unit 152 and the HoA/CID rewriting processing unit 153 described later.

The filtering processing unit 152 obtains the CID and the HoA from the terminal information table 141, upon receipt of the IP packet from the operating system 120. The filtering processing unit 152 specifies the record in which the IP address stored in the “connected IP address” agrees with the DA of the IP packet, from the terminal information table 141 and obtains the CID and HoA in the specified record.

The HoA/CID rewriting processing unit 153 rewrites the SA of the IP packet received from the operating system 120 and attaches the GMH to the IP packet. The HoA/CID rewriting processing unit 153 rewrites the SA of the IP packet received from the operating system 120 into the HoA obtained by the filtering processing unit 152. The HoA/CID rewriting processing unit 153 attaches the GMH with the CID obtained by the filtering processing unit 152 to the IP packet received from the operating system 120. The 802.16d/eMAC layer/IP layer processing unit 151 transmits a WiMAX frame with the SA rewriting processing and the GMH attaching processing thus performed externally (to the BS 41b) through the IF unit 110 and the antenna 111.

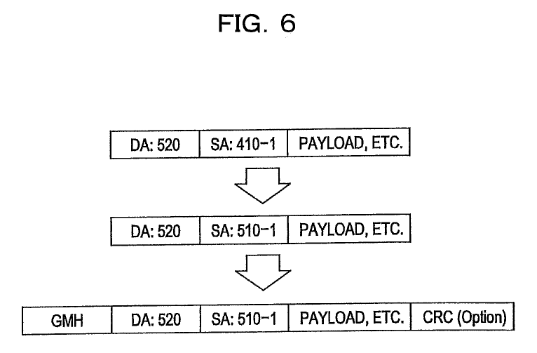

The WiMAX frame created by the above-mentioned MS 100 will be described using FIG. 6. FIG. 6 illustrates the WiMAX frame created by the MS 100. The description will be made, by way of example, taking the case where the MS 100 creates the WiMAX frame to be transmitted to the intra-server 520.

As illustrated in the upper portion of FIG. 6, the operating system 120 creates an IP packet with “520” that is the IP address of the intra-server 520 set in the “DA” and the HoA “410-1” issued by the HA 410 at the startup of the MS 100 set in the “SA”.

The filtering processing unit 152 obtains the CID “C2” and the HoA “510-1” stored correspondingly to the connected IP address “520” from the terminal information table 141. The HoA/CID rewriting processing unit 153 rewrites the “SA” of the IP packet created by the operating system 120 into “510-1” obtained by the filtering processing unit 152, as illustrated in the middle of FIG. 6.

Then, the HoA/CID rewriting processing unit 153 attaches the GMH and the CRC (Cyclic Redundancy Check) to the IP packet, as illustrated in the bottom of FIG. 6. The CID “C2” obtained by the filtering processing unit 152 is set in the GMH. The HoA/CID rewriting processing unit 153 sometimes compresses the DA and SA that are the IP header (PHS: Payload Header Suppression).

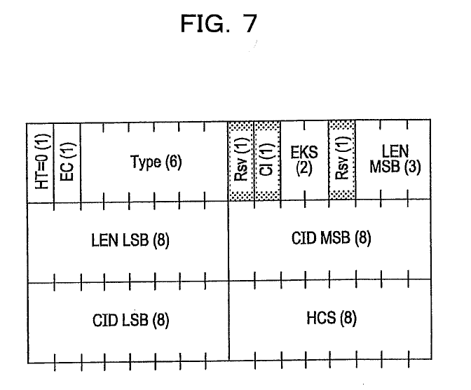

Here, FIG. 7 shows the format of the GMH. The HoA/CID rewriting processing unit 153 sets the CID obtained by the filtering processing unit 152 in the “CID MSB (Most Significant Bit)” and “CID LSB (Least Significant Bit)” of the GMH illustrated in FIG. 7.

The MS 100 transmits the thus created WiMAX frame to the ASN-GW 300 through the BS 41b. Upon receipt of the IP packet, the ASN-GW 300 encapsulates it and transfers it to the HA 510. Specifically, in the previous stage before the IP packet illustrated in the bottom of FIG. 6, the ASN-GW 300 sets the IP address of the HA 510 in the DA and attaches the IP header with the IP address of the ASN-GW 300 set to the SA, hence to transfer it to the HA 510. Upon receipt of the IP packet, the HA 510 decapsulates it and transmits it to the intra-server 52p. When the intra-server 520 transmits the data to the MS 100, it transmits the IP packet to the IP address which is set in the SA of the received IP packet.

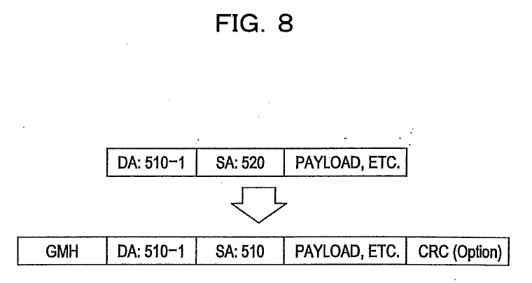

The IP packet created by the intra-server 520 will be described using FIG. 8. FIG. 8 illustrates the IP packet created by the intra-server 520 and the WiMAX frame created by the BSs 41a to 41c. The description will be made, by way of example, taking the case where the intra-server 520 creates the IP packet to be transmitted to the MS 100.

As illustrated in the top of FIG. 8, the intra-server 520 creates the IP packet with the HoA “510-1” of the MS 100 set in the “DA” and the IP address “520” of the intra-server 520 set in the “SA”.

The intra-server 520 transmits the thus created IP packet to the HA 510. Upon receipt of the IP packet, the HA 510 encapsulates it and transmits it to the ASN-GW 300. Specifically, in the previous stage before the IP packet illustrated in the top of FIG. 8, the HA 510 attaches the IP header with the IP address of the ASN-GW 300 set in the DA and the IP address of the HA 510 set in the SA and then transfers it to the ASN-GW 300. Upon receipt of the IP packet, the ASN-GW 300 decapsulates it and transmits it to the BS 41b. As illustrated in the bottom of FIG. 8, the BS 41b attaches the GMH header to the received user IP packet and transmits it to the MS 100.

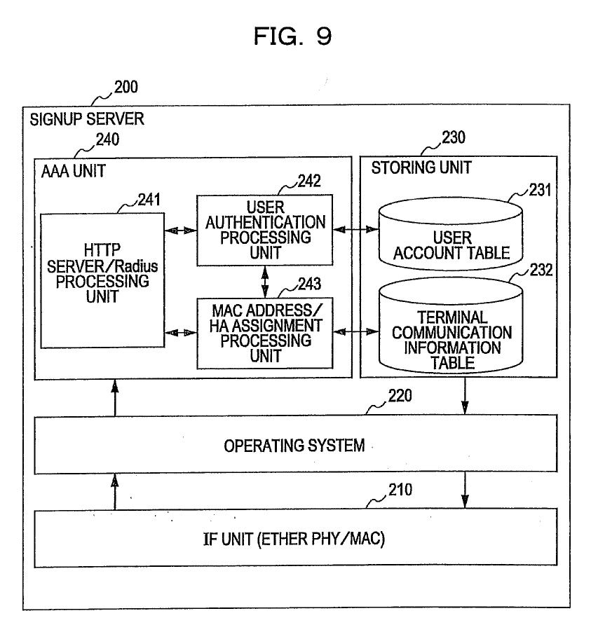

The structure of the signup server 200 illustrated in FIG. 1 will be described. FIG. 9 illustrates the signup server 200 illustrated in FIG. 1. As illustrated in FIG. 9, the signup server 200 includes an IF unit (Ether PHY/MAC) 210, an operating system 220, a storing unit 230, and an AAA unit 240.

The IF unit 210 is an interface for transmitting and receiving data to and from the other unit (ASN-GW 300, etc.). The operating system 220 is the basic software for performing the management operation of the hardware within the signup server 200.

The storing unit 230 is a storing device for storing various information, and includes a user account table 231 and a terminal communication information table 232. The user account table 231 stores various information necessary for authenticating each user.

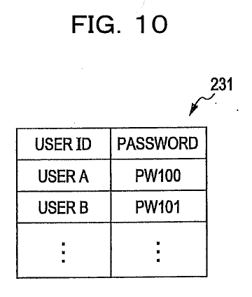

An exemplary user account table 231 is illustrated in FIG. 10. As illustrated in FIG. 10, the user account table 231 has the items of user ID and password. The “user ID” shows the user ID of each MS, for example, NAI. The “password” indicates the user's password stored in the “user ID”.

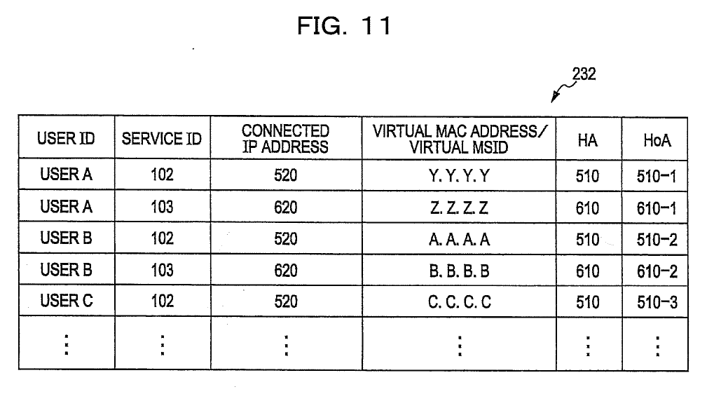

The terminal communication information table 232 stores services usable by a user and the IP address of a server which provides a service usable by the user, for every user. An exemplary terminal communication information table 232 is illustrated in FIG. 11. As illustrated in FIG. 11, the terminal communication information table 232 has the items of user ID, service ID, connected IP address, virtual MAC address/virtual MSID (Mobile Station Identifier), HA, and HoA.

The “user ID” corresponds to the user ID of the user account table 231 illustrated in FIG. 10. The “service ID” indicates the identifier for identifying a service usable by a user indicated by the user ID. The “connected IP address” indicates the IP address of a server which provides a service usable by a user indicated by the user ID.

The “virtual MAC address/virtual MSID” indicates the virtual MAC address/virtual MSID used in the case where a user indicated by the user ID uses a service indicated by the service ID. The MSID is an identifier of a terminal which is identified between the BS and the ASN-GW, and indicates the same information as the MAC address.

The “HA” indicates the IP address of an HA to which the MS 100 gains access when a user indicated by the user ID establishes communication to use a service indicated by the service ID. The “HoA” indicates an HoA assigned to the MS 100 when a user indicated by the user ID establishes communication to use a service indicated by the service ID.

The AAA unit 240 includes an HTTP server/Radius processing unit 241, a user authentication processing unit 242, and a MAC address/HA assignment processing unit 243. Upon receipt of the virtual MAC address assignment request from the MS 100, the HTTP server/Radius processing unit 241 obtains the user ID and the password included in the virtual MAC address assignment request and supplies them to the user authentication processing unit 242. The HTTP server/Radius processing unit 241 transmits the Radius message to the ASN-GW 300 and the Home AAA 530 or 630. The Radius message transmitted by the HTTP server/Radius processing unit 241 will be described later.

Upon receipt of the user ID and the password from the HTTP server/Radius processing unit 241, the user authentication processing unit 242 performs the authentication processing. The user authentication processing unit 242 checks whether a combination of the user ID and the password included in the virtual MAC address assignment request is stored in the user account table 231. When the combination of the user ID and the password agrees with that in the above table, the user authentication processing unit 242 judges as “authentication OK”. When the combination of the user ID and the password does not agree with the above, on the other hand, the user authentication processing unit 242 judges as “authentication NG”.

The MAC address/HA assignment processing unit 243 transmits the virtual MAC address, the service ID, the connected IP address, and the HoA to the MS 100. The MAC address/HA assignment processing unit 243 obtains various information stored correspondingly to the user ID included in the authentication request from the terminal communication information table 232 when the user authentication processing unit 242 judges as “authentication OK”. The MAC address/HA assignment processing unit 243 transmits the obtained service ID, connected IP address, and virtual MAC address to the MS 100. The connected IP address may be replaced with the connected URL.

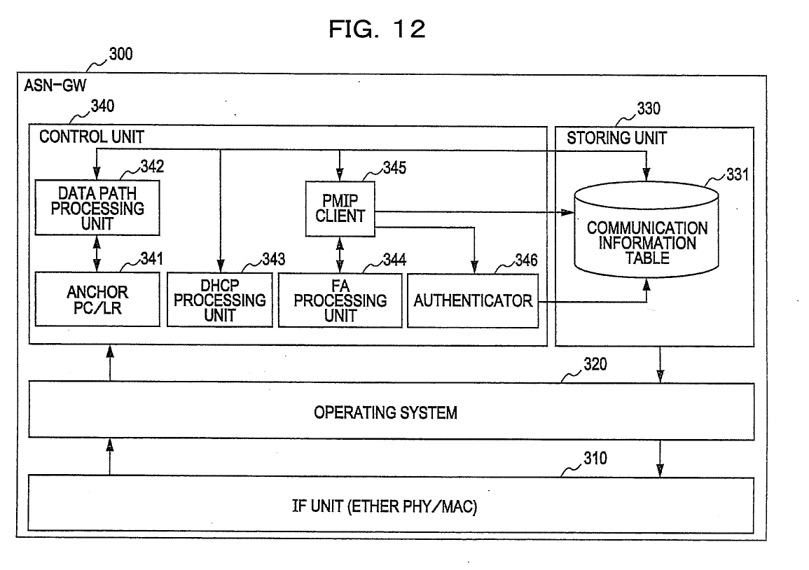

The structure of the ASN-GW 300 illustrated in FIG. 1 will be described. FIG. 12 illustrates the ASN-GW 300 illustrated in FIG. 1. As illustrated in FIG. 12, the ASN-GW 300 includes an IF unit (Ether PHY/MAC) 310, an operating system 320, a storing unit 330, and a control unit 340.

The IF unit 310 is an interface for transmitting and receiving data to and from the other unit (BS 41a to 41c, HA 410, 510 or 610, signup server 200, etc.). The operating system 320 is the basic software for performing the management operation of the hardware within the ASN-GW 300.

The storing unit 330 is a storing device for storing various information, and includes a communication information table 331. The communication information table 331 stores a service usable by a user and the IP address of a server which provides a service usable by the user, for every user.

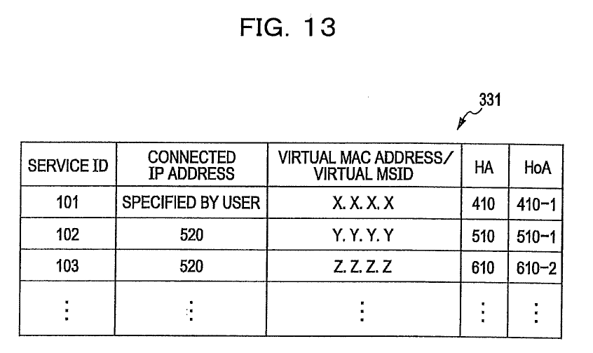

An exemplary communication information table 331 is illustrated in FIG. 13. As illustrated in FIG. 13, the communication information table 331 has the items of service ID, connected IP address, virtual MAC address/virtual MSID, HA, and HoA. The “service ID”, “connected IP address”, “virtual MAC address/virtual MSID”, “HA”, and “HoA” respectively correspond to the service ID, connected IP address, virtual MAC address/virtual MSID, HA, and HoA in the terminal communication information table 232 illustrated in FIG. 11.

The control unit 340 includes an anchor PC/LR (Paging Controller/Location Register) 341, a data path processing unit 342, a DHCP processing unit 343, an FA processing unit 344, a PMIP client 345, and an authenticator 346.

The anchor PC/LR 341 manages the positional information of the MS 100 turning into the idle mode and pages (calls) the terminal. The data path processing unit 342 manages the wireless connection state with the MS 100.

The DHCP processing unit 343 transmits and receives the DHCP message. For example, the DHCP processing unit 343 receives the DHCP. Discover message and the DHCP Request message from the MS 100. For example, the DHCP processing unit 343 transmits the DHCP Offer message and the DHCP Ack message to the MS 100.

The FA processing unit 344 capsulates the IP packet received from the MS 100 and decapsulates the IP packet received from the HA 410, 510 or 610. For example, when the FA processing unit 344 receives the IP packet illustrated in the bottom of FIG. 6 from the MS 100, as mentioned above, it attaches the header with the IP address of the HA 510 set in the SA and with the IP address of the ASN-GW 300 set in the DA to the above IP packet. For example, when the FA processing unit 344 receives the encapsulated IP packet from the HA 510, as described using FIG. 8, it decapsulates the above IP packet.

The PMIP client 345 provides a function of mobile IP even to the MS 100 which has no mobile IP function. When receiving the DHCP Discover message from the MS 100, the PMIP client 345 controls the FA processing unit 344 to transmit the Registration Request message to the HA. The PMIP client 345 controls the DHCP processing unit 343 to transmit the DHCP Offer message to the MS 100, upon receipt of the Registration Reply in reply to the registration request from the HA.

When receiving the IP packet from the MS 100, the PMIP client 345 obtains the HA in which the IP address stored in the connected IP address agrees with the IP address set in the DA of the IP packet, from the communication information table 331. The PMIP client 345 controls the FA processing unit 344 to encapsulate the IP packet using the obtained HA. The FA processing unit 344 sets the HA obtained by the PMIP client 345 in the DA and the IP address of the ASN-GW 300 in the SA, hence to encapsulate the IP packet.

When receiving the encapsulated IP packet from the HA 410, 510 or 610, the PMIP client 345 controls the FA processing unit 344 to decapsulate the above IP packet. The PMIP client 345 transmits the decapsulated IP packet externally through the data path processing unit 342.

The authenticator 346 performs the reacquisition processing of the IP address of the HA 410, 510 or 610. The authenticator 346 obtains the IP address of the HA again according to the instruction of the PMIP client 345 and replaces the tunnel between the FA and the HA with a new one.

The flow of the processing in the respective units included in the mobile IP network 1 illustrated in FIG. 1 will be described using FIGS. 12 and 13. The flow of the processing starting from the startup of the MS 100 illustrated in FIG. 1 up to the communication of the MS 100 with the intra-server 520 within the MVNO network 5 will be described. In the following description, after the MS 100 gains access to the network, it is assumed that the HA 410 is determined as the HA which performs the mobile IP client registration processing on the MS 100.

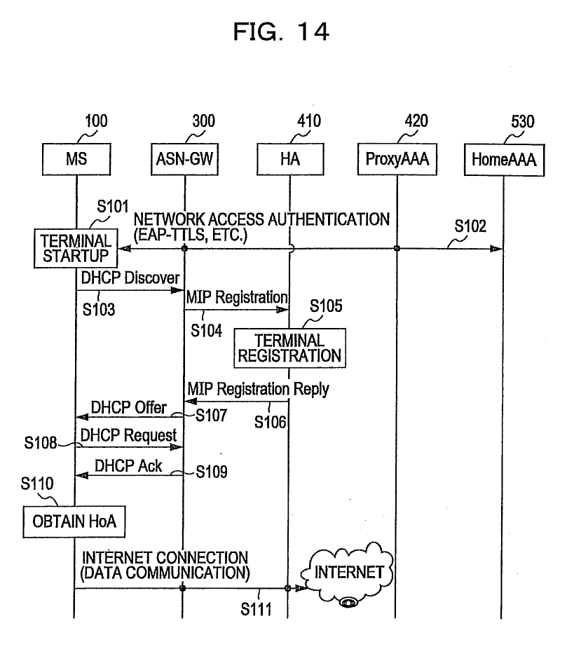

FIG. 14 illustrates exemplary processing in the respective units included in the mobile IP network 1 according to the first embodiment after startup of the MS 100. FIG. 14 illustrates the procedure of the respective units from the startup of the MS 100 to the acquisition of the HoA from the HA 410.

As illustrated in FIG. 14, after the MS 100 starts (Operation S101), network access authentication (for example, EAP-TTLS: Extensible Authentication Protocol Tunneled Transport Layer Security) is performed between the MS 100 and the Home AAA 530 (Operation S102). The network access authentication is the processing for the MS 100 to gain access to the mobile IP network 1.

The MS 100 transmits the DHCP Discover message to the ASN-GW 300 (Operation S103). Upon receipt of the DHCP Discover message, the ASN-GW 300 transmits the MIP Registration Request message to the HA 410 (Operation S104).

Upon receipt of the MIP Registration Request message, the HA 410 performs predetermined registration processing necessary for the mobile IP (Operation S105). The HA 410 transmits the MIP Registration Reply message including the HoA assigned to the MS 100 to the ASN-GW 300 (Operation S106).

Upon receipt of the MIP Registration Reply message, the ASN-GW 300 transmits the DHCP Offer message to the MS 100 (Operation S107). Upon receipt of the DHCP Offer message, the MS 100 transmits the DHCP Request message to the ASN-GW 300 (Operation S108).

Upon receipt of the DHCP Request message, the ASN-GW 300 transmits the DHCP Ack message including the HoA received from the HA 410, to the MS 100 (Operation S109). As a result, the MS 100 obtains the HoA in the case of the communication through the HA 410 (Operation S110). The MS 100 assigns the received HoA to the WiMAX interface driver.

The MS 100 receives the Internet connection service through the ASN-GW 300 and the HA 410. When the MS 100 transmits the data, it sets the HoA obtained in Operation S110 in the SA of the IP packet.

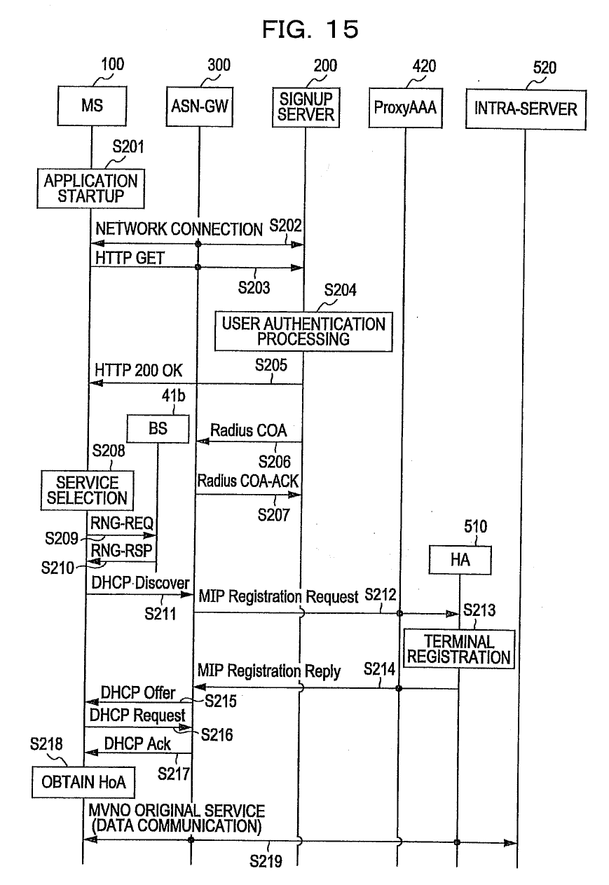

The flow of the processing in the respective units included in the mobile IP network 1 when the MS 100 works as the virtual MS will be described using FIG. 15. FIG. 15 illustrates exemplary processing in the respective units included in the mobile IP network 1 according to the first embodiment when the MS 100 works as the virtual MS. The procedure of the processing in the respective units until the MS 100 uses the service provided by the intra-server 520 will be described, after the processing illustrated in FIG. 14.

As illustrated in FIG. 15, the application layer 130 of the MS 100 activates an application to show a screen asking a user whether he or she uses the MVNO's original service on a browser (Operation S201). When receiving the user's operation of using the MVNO's original service, the MS 100 gains access to the signup server 200 (Operation S202). The MVNO authentication/virtual MAC obtaining unit 131 of the MS 100 transmits the HTTP GET message including the user ID and the password to the signup server 200 (Operation S203).

Upon receipt of the HTTP GET message, the HTTP server/Radius processing unit 241 of the signup server 200 performs the user authentication processing on the user authentication processing unit 242 (Operation S204). The user authentication processing unit 242 checks whether the combination of the user ID and the password received from the MS 100 is stored in the user account table 231.

When the user authentication processing unit 242 judges as “authentication OK”, the MAC address/HA assignment processing unit 243 of the signup server 200 obtains various information stored correspondingly to the user ID included in the authentication request, from the terminal communication information table 232. The MAC address/HA assignment processing unit 243 obtains the service ID, the connected IP address, and the virtual MAC address from the terminal communication information table 232.

The HTTP server/Radius processing unit 241 transmits the HTTP 200 OK message including the service ID, the connected IP address, and the virtual MAC address obtained by the MAC address/HA assignment processing unit 243 to the MS 100 (Operation S205).

The HTTP server/Radius processing unit 241 transmits the Radius COA message including the service ID, the connected IP address, the virtual MAC address, the HA, and the HoA obtained by the MAC address/HA assignment processing unit 243 to the ASN-GW 300 (Operation S206).

Upon receipt of the Radius COA message, the authenticator 346 of the ASN-GW 300 sets various information included in the message in the PMIP client 345 and stores the obtained various information in the communication information table 331. The authenticator 346 transmits the Radius COA-ACK message to the signup server 200 (Operation S207).

Upon receipt of the HTTP 200 OK message from the signup server 200, the application layer 130 of the MS 100 shows a list of the service name indicated by the received service ID and the name of the MVNO providing the service, for example, on a browser. According to this, the MS 100 prompts a user to select a service he or she wants to use (Operation S208).

When a user selects a service, the 802.16d/eMAC layer/IP layer processing unit 151 of the MS 100 obtains the virtual MAC address corresponding to the service ID of the selected service from the terminal information table 141. The 802.16d/eMAC layer/IP layer processing unit 151 transmits the RNG-REQ message including the obtained virtual MAC address to the BS 41b (Operation S209).

Here, it is assumed that the MS 100 selects to use the service (chat service) provided by the intra-server 520. Namely, the 802.16d/eMAC layer/IP layer processing unit 151 obtains the virtual MAC address “Y.Y.Y.Y” stored correspondingly to the service ID “102” from the terminal information table 141. The 802.16d/eMAC layer/IP layer processing unit 151 transmits the RNG-REQ message including the virtual MAC address “Y.Y.Y.Y” to the BS 41b (Operation S209).

Upon receipt of the RNG-REQ message, the BS 41b checks the authentication information of the MS 100 and when judging the MS 100 as a normal terminal, it transmits the RNG-RSP message including the CID to the MS 100 (Operation S210). Upon receipt of the RNG-RSP message, the MS 100 stores the obtained CID in the terminal information table 141. Here, it is assumed that the CID included in the RNG-RSP message is “C2”. Namely, the MS 100 stores the “C2” in the CID corresponding to the service ID “102” selected by a user, as illustrated in the example of the terminal information table 141 in FIG. 5.

The MS 100 performs the mobile IP registration of the virtual MS. The 802.16d/eMAC layer/IP layer processing unit 151 of the MS 100 transmits the DHCP Discover message including the virtual MAC address “Y.Y.Y.Y” to the ASN-GW 300 (Operation S211).

Upon receipt of the DHCP Discover message, the PMIP client 345 of the ASN-GW 300 makes the FA processing unit 344 transmit the Registration Request message to the HA 510 (Operation S212). The FA processing unit 344 obtains the HA “510” and the HoA “510-1” stored correspondingly to the virtual MAC address “Y.Y.Y.Y” from the communication information table 331. The FA processing unit 344 transmits the Registration Request message including the HoA “510-1” to the HA 510 having the IP address “510”.

Upon receipt of the Registration Request message, the HA 510 registers the MS 100 working as the virtual MS (Operation S213). The HA 510 manages the HoA “510-1” and the IP address of the ASN-GW 300 as a set. The HA 510 transmits the MIP Registration Reply message to the ASN-GW 300 (Operation S214).

Upon receipt of the MIP Registration Reply message, the DHCP processing unit 343 of the ASN-GW 300 transmits the DHCP Offer message to the MS 100 (Operation S215). Upon receipt of the DHCP Offer message, the MS 100 transmits the DHCP Request message to the ASN-GW 300 (Operation S216).

Upon receipt of the DHCP Request message, the DHCP processing unit 343 of the ASN-GW 300 obtains the HoA “510-1” stored correspondingly to the virtual MAC address “Y.Y.Y.Y” from the communication information table 331. The DHCP processing unit 343 transmits the DHCP Ack message including the obtained HoA “510-1” to the MS 100 (Operation S217).

Upon receipt of the DHCP Ack message, the MS 100 obtains the HoA “510-1” from the DHCP Ack message (Operation S218). The MS 100 stores the HoA “510-1” in the HoA corresponding to the virtual MAC address “Y.Y.Y.Y” in the terminal information table 141.

The MS 100 establishes communication with the intra-server 520 through the ASN-GW 300 and the HA 510 (Operation S219). The MS 100 transmits the IP packet with the IP address “520” of the intra-server 520 set in the DA and “510-1” set in the SA. According to this, the MS 100 can make use of the original service provided by the MVNO network 5 (chat service provided by the intra-server 520 in the example illustrated in FIG. 1).

FIG. 15 illustrates the example of transmitting the HTTP 200 OK message including the service ID, the connected IP address, and the virtual MAC address to the MS 100 from the signup server 200, in the procedure shown in Operation S205. In the procedure, however, the HTTP 200 OK message further including the HoA may be transmitted from the signup server 200.

As mentioned above, the mobile IP network 1 according to an exemplary embodiment establishes communication by changing the HoA depending on a service used by the MS 100. Accordingly, the MS 100 can make use of an original service provided by another MVNO with which the MS 100 does not have a contract, in addition to an original service provided by the MVNO with which it has a contract. Since the MS 100 switches the connected HAs for every service, any other traffic than the original service provided by the MVNO can be offloaded to the HA in the WiMAX core network, thereby restraining the traffic into the MVNO network.

As a result, a user can make use of a service providing by another MVNO without changing the contract with his or her contracted MVNO. Further, the MVNO can reduce a possibility that the own user cancels the contract for the reason of using a service of another MVNO. Further, the MVNO can provide the own service to a user who does not have a contract with itself. The WiMAX business owner can allow a user to use the services provided by a plurality of MVNOs. According to this, use of the mobile IP network 1 of the first embodiment gives respective merits to a user, MVNO, and a WiMAX business owner.

The Proxy AAA 420 may total up the accounting information per every MS by obtaining the accounting information for every MS from the ASN-GW 300 and the HAs 410, 510, and 610. In this manner, even when the MS operates as a virtual MS, the WiMAX business owner and the MVNO can grasp the accounting information by the unit of MS.

By installing a plurality of mobile IP clients in the ASN-GW or the MS and connecting the respective clients to the respective HAs, one MS could connect to a plurality of HAs. This method, however, increases the processing loads on the MS or the ASN-GW. When a plurality of mobile IP clients are installed in the ASN-GW, the ASN-GW refers to the information of Layer 7 such as URL (Uniform Resource Locator), in order to disperse the traffic to the respective mobile IP tunnels. Therefore, this method much increases the processing loads on the ASN-GW. When a plurality of mobile IP clients are installed in the MS, the MS performs the processing for a plurality of mobile IP clients. Therefore, this method much increases the processing load on the MS.

On the other hand, according to the mobile IP network 1 of the first embodiment, one MS can gain access to a plurality of HAs by referring to the information of Layer 2. In other words, the mobile IP network 1 according to the first embodiment enables one MS to connect to a plurality of HAs without increasing the processing load.

The above exemplary embodiment is an example in which the signup server 200 assigns a virtual MAC address to the MS 100 upon receipt of the virtual MAC address assignment request from the MS 100. Alternatively, the virtual MAC address assignment processing may be performed by the Home AAA. A second exemplary embodiment includes a mobile IP network 11 where the Home AAA performs the virtual MAC address assignment processing upon receipt of a virtual MAC address assignment request from the MS 100.

The structure of the mobile IP network 11 according to the second embodiment is similar as that of the mobile IP network 1 illustrated in FIG. 1. In the second embodiment, the example in which the Home AAA 530 performs the virtual MAC address assignment upon receipt of the virtual MAC address assignment request from the MS 100 will be described. The virtual MAC address assignment may be performed by the Home AAA 630.

At first, a signup server (assumed as signup server 700) in the second embodiment will be described. The structure of the signup server 700 in the second embodiment is similar as that of the signup server 200 illustrated in FIG. 9. Upon receipt of a virtual MAC address assignment request from the MS 100, the HTTP server/Radius processing unit (assumed as HTTP server/Radius processing unit 741) in the signup server 700 obtains the user ID and password included in the virtual MAC address assignment request. The HTTP server/Radius processing unit 741 transmits a Radius Access Request message including the obtained user ID to the Home AAA 530.

The HTTP server/Radius processing unit 741 receives a Radius Access Accept message from the Home AAA 530 in replay to the Radius Access Request message. The Radius Access Accept message includes virtual MAC address, service ID, connected IP address, and HoA. The HTTP server/Radius processing unit 741 transmits the virtual MAC address, the service ID, the connected IP address, and the HoA to the MS 100.

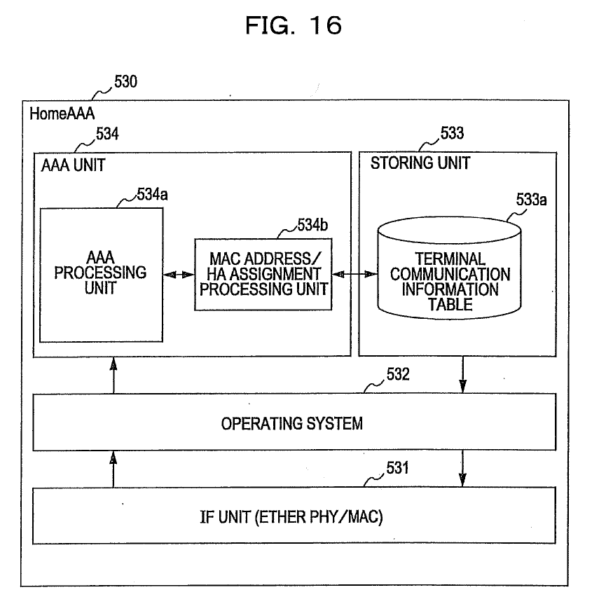

The structure of the Home AAA 530 according to the second embodiment will be described. FIG. 16 illustrates the Home AAA 530. As illustrated in FIG. 16, the Home AAA 530 includes an IF unit (Ether PHY/MAC) 531, an operating system 532, a storing unit 533, and an AAA unit 534.

The IF unit 531 is an interface for transmitting and receiving data to and from the other device (signup server 200). The operating system 532 is the basic software for performing the management operation of the hardware within the Home AAA 530.

The storing unit 533 is a storing device for storing various information, and includes a terminal communication information table 533a. The terminal communication information table 533a has a similar structure as the terminal communication information table 232 illustrated in FIG. 11. The terminal communication information table 232 includes user ID, service ID, connected IP address, virtual MAC address/virtual MSID, HA, and HoA.

The AAA unit 534 includes an AAA processing unit 534a and a MAC address/HA assignment processing unit 534b. The AAA processing unit 534a performs network access authentication processing upon receipt of a network access authentication request from the MS 100.

The MAC address/HA assignment processing unit 534b transmits the virtual MAC address, the service ID, the connected IP address, and the HoA to the MS 100, similarly to the above mentioned MAC address/HA assignment processing unit 243.

When the MAC address/HA assignment processing unit 534b receives a Radius Access Request message from the signup server 700, it obtains the user ID included in the Radius Access Request message. The MAC address/HA assignment processing unit 534b obtains the virtual MAC address stored correspondingly to the user ID, from the terminal communication information table 533a. The MAC address/HA assignment processing unit 534b transmits the Radius Access Accept message including the obtained service ID, connected IP address, and virtual MAC address to the MS 100.

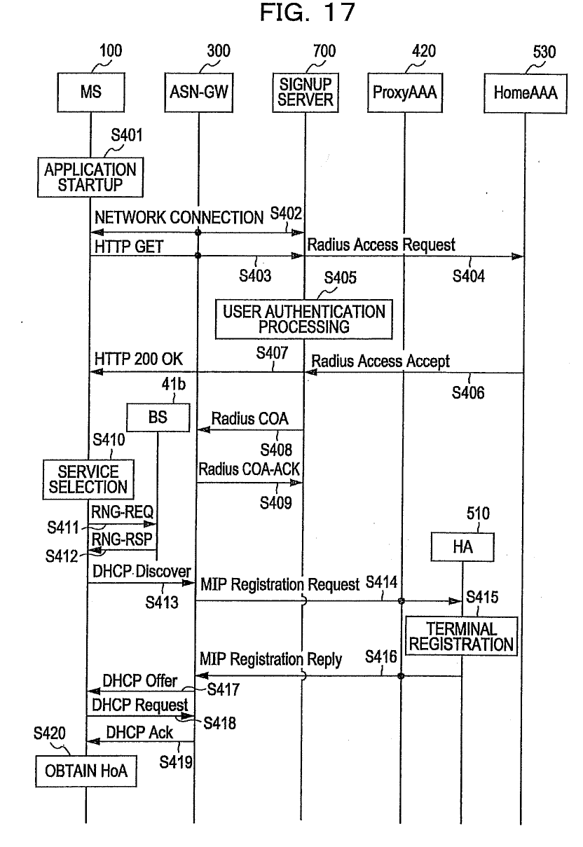

The flow of the processing in the respective units included in the mobile IP network 11 when the MS 100 operates as a virtual MS will be described. FIG. 17 illustrates exemplary processing in the respective units included in the mobile IP network 11 according to the second embodiment when the MS 100 operates as a virtual MS. The description of similar procedures (Operation S401, S402, and S408 to S420) as those illustrated in FIG. 15 is omitted.

As illustrated in FIG. 17, the HTTP server/Radius processing unit 741 of the signup server 700 receives the HTTP GET message from the MS 100 (Operation S403). In this case, the HTTP server/Radius processing unit 741 transmits the Radius Access Request message including the user ID to the Home AAA 530 (Operation S404). The HTTP server/Radius processing unit 741 makes the user authentication processing unit 242 perform the user authentication (Operation S405).

The MAC address/HA assignment processing unit 534b of the Home AAA 530 obtains the user ID included in the Radius Access Request message received from the signup server 700. The MAC address/HA assignment processing unit 534b obtains the virtual MAC address stored correspondingly to the user ID, from the terminal communication information table 533a. The MAC address/HA assignment processing unit 534b transmits the Radius Access Accept message including the obtained service ID, connected IP address, virtual MAC address, and HoA to the MS 100 (Operation S406).

The HTTP server/Radius processing unit 741 of the signup server 700 obtains the service ID, the connected IP address, the virtual MAC address, and the HoA included in the Radius Access Accept message. The HTTP server/Radius processing unit 741 transmits the HTTP 200 OK message including the service ID, the connected IP address, and the virtual MAC address to the MS 100 (Operation S407) when the user authentication processing unit 242 judges as authentication OK.

As mentioned above, in the mobile IP network 11 according to the second embodiment, the signup server 700 obtains the service ID, connected IP address, and virtual MAC address from the Home AAA 530 installed in the MVNO network 5. The signup server 700 transmits the obtained service ID, connected IP address, and virtual MAC address to the MS 100. Accordingly the service ID, the connected IP address, and the virtual MAC address are not managed by the signup server 700 but managed by the Home AAA 530. As a result, the MVNO can cope with a change of the connected IP address by maintaining the Home AAA 530 arranged in the own network, without maintenance of the signup server 700 arranged in the WiMAX core network 4.

The second embodiment illustrates an example of managing all the information including the service ID, connected IP address, virtual MAC address, and HoA by the Home AAA 530. However, the signup server 700 and the Home AAA 530 may manage the information divided between the two. For example, the signup server 700 may manage the virtual MAC address and the Home AAA 530 may manage the service ID other than the virtual MAC address or the virtual MAC address.

The first and the second exemplary embodiments illustrate the assignment processing of the virtual MAC address and the like to the MS 100 by the respective units within the mobile IP network. The respective units may perform the processing of releasing the virtual MAC address and the like assigned to the MS 100 after a predetermined elapse of time since the above assignment. A third exemplary embodiment includes processing of releasing the virtual MAC address and the like assigned to the MS 100 after a predetermined elapse of time since the above assignment. The releasing processing by the respective units illustrated in the first embodiment will be hereinafter described.

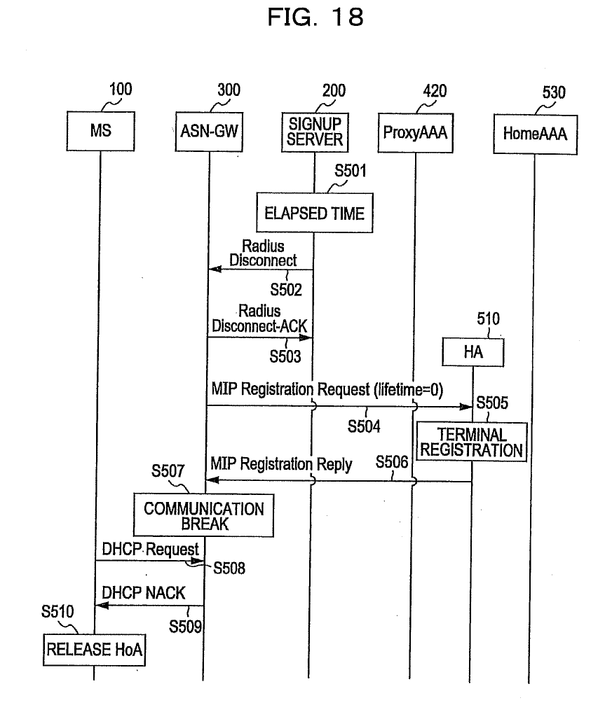

FIG. 18 illustrates exemplary processing by the respective units included in the mobile IP network 1 when the virtual MAC address and the like assigned to the MS 100 are released. As illustrated in FIG. 18, the user authentication processing unit 242 of the signup server 200 measures the elapsed time from the point when the MAC address/HA assignment processing unit 243 transmits the virtual MAC address and the like to the MS 100. The user authentication processing unit 242 activates the HTTP server/Radius processing unit 241 when the elapsed time exceeds a predetermined time (Operation S501).

The HTTP server/Radius processing unit 241 transmits the Radius Disconnect message including the user ID, virtual MAC address, and HoA with the predetermined time elapsing since the assignment to the MS 100, to the ASN-GW 300 (Operation S502). It is assumed that the predetermined time has elapsed since the MAC address/HA assignment processing unit 243 transmits, for example, the virtual MAC address “Y.Y.Y.Y” to the MS 100. In this case, the HTTP server/Radius processing unit 241 transmits the Radius Disconnect message including the user ID “user A”, the virtual MAC address “Y.Y.Y.Y”, and the HoA “510-1” to the ASN-GW 300.

The authenticator 346 of the ASN-GW 300 terminates the Radius Disconnect message received from the signup server 200. The authenticator 346 deletes the record corresponding to the user ID, virtual MAC address, and HoA included in the message, from the communication information table 331. In the case of the above example, the authenticator 346 deletes the record corresponding to the user ID “user A”, the virtual MAC address “Y.Y.Y.Y”, the HoA “510-1”, from the communication information table 331.

After the authenticator 346 deletes the record, the PMIP client 345 transmits the Radius Disconnect-ACK message to the signup server 200 (Operation S503).

The authenticator 346 controls the PMIP client 345 to delete the terminal registration into the HA. The PMIP client 345 transmits the MIP Registration Request message with “0” set in the “lifetime” to the HA 510 (Operation S504).

Upon receipt of the MIP Registration Request message, the HA 510 deletes the terminal registration information indicated by the HoA included in the message (Operation S505). In the case of the above example, the HA 510 deletes the terminal registration information indicated by HoA “510-1”. The HA 510 transmits the MIP Registration Reply message to the ASN-GW 300 (Operation S506).

The ASN-GW 300 cuts off the service (Operation S507), by abandoning all the data (IP packets) exchanged between the virtual MS indicated by the deleted HoA and the HA 510. The DHCP processing unit 343 of the ASN-GW 300 transmits the DHCP NACK message to the MS 100 (Operation S509) when receiving the DHCP Request message requesting the continuous use of the HoA “510-1”, from the MS 100 (Operation S508).

The 802.16d/eMAC layer/IP layer processing unit 151 of the MS 100 deletes the record of the HoA targeted by the DHCP NACK message (Operation S510) from the terminal information table 141 through the filtering processing unit 152. In the case of the above example, the filtering processing unit 152 deletes the record corresponding to the HoA “510-1”, from the terminal information table 141.

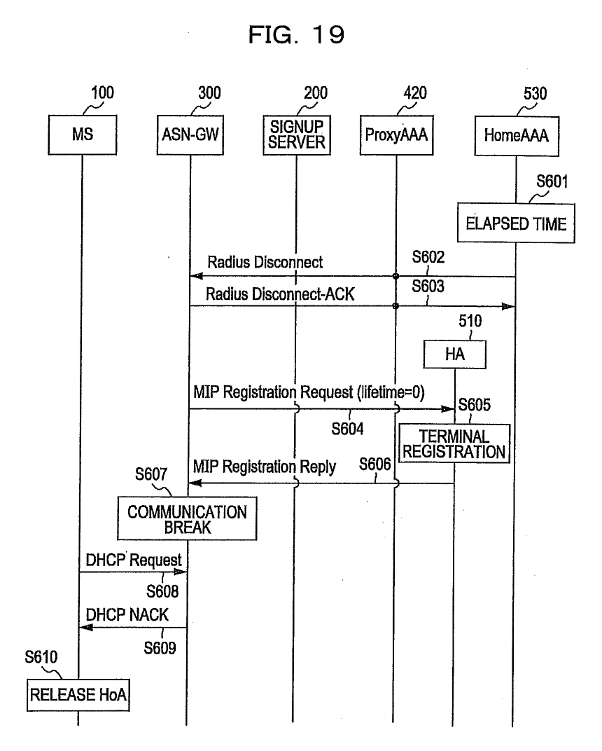

The above description using FIG. 18 is the example of measuring the elapsed time by the signup server 200 but the Home AAA 530 may measure the elapsed time. In the following description, the flow of the processing in the respective units included in the mobile IP network 1 when the Home AAA 530 measures the elapsed time will be described. FIG. 19 illustrates exemplary processing in the respective units included in the mobile IP network 1 when the Home AAA 530 measures the elapsed time. The description of similar procedures (Operation S604 to S610) as those illustrated in FIG. 18 is omitted here.

As illustrated in FIG. 19, the AAA processing unit 534a of the Home AAA 530 measures the elapsed time from the point when the MAC address/HA assignment processing unit 534b transmits the virtual MAC address and the like. When the elapsed time exceeds a predetermined time (Operation S601), the AAA processing unit 534a transmits the Radius Disconnect message including the expired user ID, virtual MAC address, and HoA since the assignment to the MS 100, to the ASN-GW 300 (Operation S602).

After the ASN-GW 300 deletes the record from the communication information table 331, the Home AAA 530 receives the Radius Disconnect-ACK message (Operation S603).

As mentioned above, the mobile IP network according to the third embodiment puts communication restrictions on the virtual MS using the virtual MAC address when a predetermined time has elapsed since the virtual MAC address is assigned to the MS 100. According to the mobile IP network of the third embodiment, the MVNO can put restrictions on the using hour of its own service.

Although the third embodiment has taken the example in which the signup server 200 measures the time elapsing since the assignment of the virtual MAC address to the MS 100, the signup server 200 may measure any other time. For example, the signup server 200 may measure the communication time of the MS 100 and when the measurement time exceeds a predetermined time, the signup server 200 may put communication restrictions on this MS 100. Alternatively, the signup server 200 may measure the time elapsing since the HoA is issued by the MS 100.

The above first to third embodiments have taken the example in which the user authentication processing unit 242 of the signup server 200 performs the authentication processing by checking whether the combination of the user ID and password transmitted from the MS 100 is stored in the user account table 231. The user authentication processing unit 242, however, may perform the authentication processing according to the other method.

For example, the user authentication processing unit 242 may put restrictions on the number of MSs simultaneously accessible to a server indicated by the connected IP address. For example, when the number of MSs connecting to the intra-server 520 indicated by the connected IP address “520” is larger than a predetermined number, the user authentication processing unit 242 may refuse the virtual MAC address assignment request received from an MS or may judge as “Authentication NG”. According to this, the MVNO can avoid an increase in load on the server by previously putting restrictions on the number of access in every server providing services.

Further, for example, the user authentication processing unit 242 may put restrictions on the number of MSs simultaneously accessible to one HA. For example, when the number of the MSs connecting to the HA 510 is larger than a predetermined number, the user authentication processing unit 242 may refuse the virtual MAC address assignment request received from the MS or may judge as “Authentication NG”. According to this, the MVNO can avoid an increase in load on the HA by previously putting restrictions on the number of the MSs accessible to the HA.

Further, for example, the user authentication processing unit 242 may put restrictions on the number of the virtual MSs possible by one MS. For example, when the number of the HoAs assigned to the MS 100 is larger than a predetermined number, the user authentication processing unit 242 may refuse the virtual MAC address assignment request received from the MS 100 or may judge as “Authentication NG”. According to this, the MVNO can put restrictions on the number of the virtual MAC addresses assigned to the MS and the number of the HoAs, and can reduce the resource amount managed by the signup server 200, the ASN-GW 300, and the HA 510. Further, the MVNO can avoid an increase in load on the MS by previously putting restrictions on the number of the possible virtual MSs.

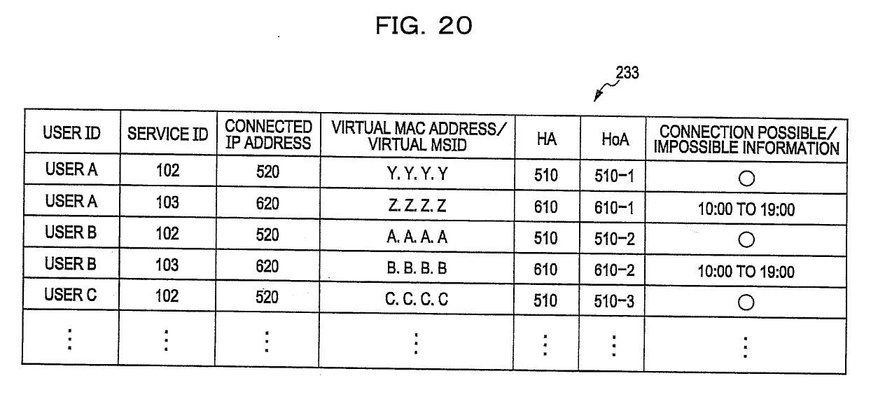

Further, the user authentication processing unit 242 may check whether a service indicated by the service ID is now being served. For example, when the service 102 provided by the A company of MVNO is served between 0800 to 1700, there is no use in making it possible to use the service 102 out of the service hours. In this case, the signup server 200 further records the item indicating whether a service is now being served, into the terminal communication information table. FIG. 20 is used to describe the terminal communication information table (regarded as the terminal communication information table 233).

FIG. 20 illustrates an exemplary terminal communication information table 233. As illustrated in FIG. 20, the terminal communication information table 233 further includes the item of connection possible/impossible information, compared with the terminal communication information table 232 illustrated in FIG. 11. The connection possible/impossible information indicates whether the service indicated by the corresponding service ID is now being served. The example of the terminal communication information table 232 illustrated in FIG. 20 shows that the services indicated by the service ID “102” illustrated in the first, third, and fifth lines are always being served. In the example of the terminal communication information table 232 illustrated in FIG. 20, the services indicated by the service ID “103” illustrated in the second and fourth lines are served between 1000 to 1900. When there is no service being served, the user authentication processing unit 242 may refuse the virtual MAC address assignment request from the MS or may judge as “Authentication NG”.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal.

Further, according to an aspect of the embodiments, any combinations of the described features, functions and/or operations can be provided.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. A communication system having a mobile unit, a terminal control unit for managing information about the mobile unit, and a mobile unit relay unit for transferring data transmitted from the mobile unit to another relay unit depending on source IP address, wherein
the mobile unit relay unit includes:
a communication information storing unit which stores a terminal identifier for identifying the mobile unit for every relay unit, which is notified from the terminal control unit to the mobile unit depending on a request from the mobile unit and a mobile IP address assigned to the mobile unit for every terminal identifier; and
an IP address transmitting unit which transmits the mobile IP address stored in the communication information storing unit correspondingly to the terminal identifier, to the mobile unit, upon receipt of an IP address assignment request and the terminal identifier of the mobile unit from the mobile unit, and
the mobile unit includes:
a communication unit which establishes communication with a predetermined terminal, with the mobile IP address received from the IP address transmitting unit as the source IP address.

2. The communication system according to claim 1, wherein the terminal control unit includes:
a terminal communication information storing unit which stores a destination IP address and the terminal identifier for identifying the mobile unit for every relay unit; and
a terminal identifier transmitting unit which transmits a combination of the destination IP address and the terminal identifier stored in the terminal communication information storing unit to the mobile unit, upon receipt of a terminal identifier assignment request from the mobile unit, requesting assignment of the terminal identifier to the mobile unit, and
the mobile unit includes:
a terminal identifier assignment requesting unit which transmits the terminal identifier assignment request to the terminal control unit;
an IP address assignment requesting unit which, in establishing communication with a predetermined terminal, specifies a terminal identifier with the destination IP address corresponding to the IP address of the predetermined terminal, from the combinations of the destination IP address and the terminal identifier transmitted by the terminal identifier transmitting unit and transmits the IP address assignment request including the specified terminal identifier to the mobile unit relay unit; and
a communication unit which establishes communication with the predetermined terminal with the IP address transmitted by the IP address transmitting unit as the source IP address.

3. The communication system according to claim 2, wherein the terminal control unit further includes:
a user storing unit which stores a user identifier for identifying a user of the mobile unit and a password of the user; and
a user authentication unit which checks whether a combination of the user identifier and the password is stored in the user storing unit, upon receipt of the terminal identifier assignment request including the user identifier and the password from the mobile unit,
the terminal communication information storing unit further stores the user identifier, and
the IP address transmitting unit transmits the combination of the destination IP address and the terminal identifier stored in the terminal communication information storing unit correspondingly to the user identifier, when the user authentication unit judges that the combination of the user identifier and the password included in the terminal identifier assignment request is stored in the user storing unit.

4. The communication system according to claim 3, wherein the terminal communication information storing unit further stores connection possible/impossible information indicating whether a terminal of a communicating party having the IP address corresponding to the destination IP address is in operation or not,
the user authentication unit checks whether the terminal of the communicating party is in operation or not, based on the connection possible/impossible information stored in the terminal communication information storing unit correspondingly to the user identifier included in the terminal identifier assignment request, upon receipt of the terminal identifier assignment request from the mobile unit, and
the IP address transmitting unit transfers the combination of the destination IP address and the terminal identifier to the mobile unit when the user authentication unit judges that the terminal of the communicating party is in operation.

5. The communication system according to claim 3, wherein the user authentication unit refuses the IP address assignment request received from the mobile unit when the number of the relay units having the data transferred is larger than a predetermined number, in communication performed by the communication unit using the mobile IP address.

6. The communication system according to claim 3, wherein the user authentication unit refuses the IP address assignment request received from the mobile unit when the number of the mobile IP addresses transmitted by the IP address transmitting unit to the mobile unit is larger than a predetermined number.

7. The communication system according to claim 2, wherein the terminal control unit includes:
a communication time measuring unit which measures a communication time performed by the communication unit, for every mobile IP address; and
a communication break unit which breaks the communication using the mobile IP address, in every mobile IP address, when the communication time measured by the communication time measuring unit exceeds a predetermined time.

8. The communication system according to claim 2, further comprising:
a proxy unit which obtains accounting information concerning the communication by the mobile unit from the mobile unit relay unit or the other relay unit and totals up the accounting information for every mobile unit.

9. A terminal control unit which manages information about a mobile unit which transmits data to a mobile unit relay unit of transferring data to another relay unit depending on source IP address, comprising:
a terminal communication information storing unit which stores a destination IP address and a terminal identifier for identifying the mobile unit for every relay unit; and
a terminal identifier transmitting unit which transmits a combination of the destination IP address and the terminal identifier stored in the terminal communication information storing unit to the mobile unit, upon receipt of a terminal identifier assignment request from the mobile unit, requesting assignment of the terminal identifier to the mobile unit.

10. A communication method among a mobile unit, a terminal control unit for managing information about the mobile unit, and a mobile unit relay unit for transferring data transmitted from the mobile unit to another relay unit depending on source IP address, wherein
the terminal control unit includes:
a terminal identifier transmitting process of transmitting a combination of a destination IP address and a terminal identifier stored in a terminal communication information storing unit which stores the destination IP address and the terminal identifier, to the mobile unit, upon receipt of a terminal identifier assignment request from the mobile unit, requesting assignment of the terminal identifier for identifying the mobile unit for every relay unit to the mobile unit,
the mobile unit relay unit includes:
an IP address transmitting process of transmitting a mobile IP address to the mobile unit, the mobile IP address being stored in the communication information storing unit for storing a terminal identifier and the mobile IP address that is the IP address assigned to the mobile unit for every terminal identifier, correspondingly to the terminal identifier, upon receipt of the terminal identifier of the mobile unit from the mobile unit together with an IP address assignment request requesting assignment of the IP address to the mobile unit, and
the mobile unit includes:
a terminal identifier assignment requesting process of transmitting the terminal identifier assignment request to the terminal control unit;
an IP address assignment requesting process of, in establishing communication with a predetermined terminal, specifying a terminal identifier with the destination IP address corresponding to the IP address of the predetermined terminal, from the combinations of the destination IP address and the terminal identifier transmitted through the terminal identifier transmitting process and transmitting the IP address assignment request including the specified terminal identifier to the mobile unit relay unit; and
a communication process of establishing communication with the predetermined terminal with the IP address transmitted through the IP address transmitting process as the source IP address.

11. The communication method according to claim 10, wherein the terminal control unit further includes:
a user authentication process of checking whether a combination of a user identifier and a password is stored in a user storing unit which stores the user identifier and the password, upon receipt of the terminal identifier assignment request including the user identifier for identifying a user of the mobile unit and the password of the user from the mobile unit,
the terminal communication information storing unit further stores the user identifier, and
the IP address transmitting process includes an operation of transmitting to the mobile unit, the combination of the destination IP address and the terminal identifier stored in the terminal communication information storing unit correspondingly to the user identifier, when it is judged in the user authentication process that the combination of the user identifier and the password included in the terminal identifier assignment request is stored in the user storing unit.

12. The communication method according to claim 11, wherein the terminal communication information storing unit further stores connection possible/impossible information indicating whether the terminal of a communicating party having the IP address corresponding to the destination IP address is in operation or not,
the user authentication process includes an operation of checking whether the terminal of the communicating party is in operation or not, based on the connection possible/impossible information stored in the terminal communication information storing unit correspondingly to the user identifier included in the terminal identifier assignment request, upon receipt of the terminal identifier assignment request from the mobile unit, and
the IP address transmitting process includes operation of transmitting the combination of the destination IP address and the terminal identifier to the mobile unit when it is judged in the user authentication process that the terminal of the communicating party is in operation.

13. The communication method according to claim 11, wherein the user authentication process includes an operation of refusing the IP address assignment request received from the mobile unit when the number of the relay units having the data transferred is larger than a predetermined number, in communication performed using the mobile IP address in the communication process.

14. The communication method according to claim 11, wherein the user authentication process includes an operation of refusing the IP address assignment request received from the mobile unit when the number of the mobile IP addresses transmitted to the mobile unit through the IP address transmitting process is larger than a predetermined number.

15. The communication method according to claim 10, wherein the terminal control unit includes:
a communication time measuring process of measuring a communication time performed through the communication process, for every mobile IP address; and
a communication break process of breaking the communication using the mobile IP address, in every mobile IP address, when the communication time measured through the communication time measuring process exceeds a predetermined time.

16. A system comprising:
a mobile unit relay unit including a storing unit which stores an identifier for a first mobile unit for every relay unit; and
a transmitting unit which transmits a mobile IP address corresponding to the identifier to a second mobile unit upon receipt of an IP address assignment request and the identifier,
wherein the second mobile unit establishes communication with a terminal with the IP address received from the IP address transmitting unit as the source IP address.

17. A communication method comprising:
transmitting a destination IP address and a terminal identifier upon receiving a request for assignment of the terminal identifier for every relay unit to the mobile unit;
transmitting a mobile IP address to a mobile unit upon receipt of the terminal identifier of the mobile unit from the mobile unit together with an IP address assignment request requesting assignment of the IP address to the mobile unit, and
transmitting a terminal identifier assignment request;
specifying a terminal identifier with a terminal IP address from combinations of a destination IP address and the terminal identifier:
transmitting an IP address assignment request including the specified terminal identifier; and
communicating with a terminal with the transmitted IP address.
